(19) United States
(12) Patent Application Publication
(10) Pub. No.: US 2004/0022619 A1
(43) Pub. Date: Feb. 5, 2004

(54) Method and device for picking up stacks of blanks

(76) Inventors: Mario Spatafora, Bologna (IT); Franco Carini, Granarolo Dell'Emilia (IT)

Correspondence Address: LADAS & PARRY, 26 WEST 61ST STREET, NEW YORK, NY, 10023, US

(21) Appl. No.: 10/311,055

(22) PCT Filed: Jun. 15, 2001
(86) PCT No.: PCT/IT01/00318

(30) Foreign Application Priority Data
Jun. 16, 2000 (IT) BO2000A000356

(51) Int. Cl. B65G 59/02

(52) U.S. Cl. 414/796.9; 414/792.9; 414/793.4; 414/794.3; 414/796; 414/907

(57) ABSTRACT

A method of picking up stacks (3) of blanks by means of a gripping device (1) having a gripper (13, 14, 15) hinged to a frame (11) and equipped with a first gripping member (15) having a free end (P); and actuating means (30, 41; 24, 25) for opening and closing the gripper (13, 14, 15); the method providing for pressing the free end (P) on a support (F) on which a stack (3) for pickup rests, and feeding the free end (P) along the support (F) and beneath the stack (3) while pressing the free end (P) against the support (F).

### TECHNICAL FIELD

The present invention relates to a method of picking up stacks of blanks.

More specifically, the present invention relates to a method of picking up stacks of blanks to transfer a given number of stacks, stacked on a pallet, one at a time to a cigarette packing machine, to which the following description refers purely by way of example.

### BACKGROUND ART

Stacks of blanks normally comprise a number of flat blanks substantially aligned one on top of the other and held together by a wrapper. The stacks are arranged in layers stacked on the pallet and separated by dividers, each for supporting the stacks in a respective layer. The pallets are moved up to a robot, which is equipped with a gripping device for transferring one stack at a time to the input station of the packing machine. The robot positions the gripping device at the stack for pickup, and the device grips the stack between two gripping members.

A gripping device of this sort must be set by the robot to a precise position with respect to the stack for pickup, so as to prevent the gripping members from interfering with the blanks at the pickup stage, which is further complicated by the stacks being arranged contacting one another in each layer, so that the gripping members may also interfere with and possibly damage the blanks in the adjacent stacks. For it to be positioned accurately at the stack for pickup, the gripping device must be equipped with a number of optical sensors or even cameras, which monitor the positions of the ends of the gripping members with respect to the stack for pickup and the adjacent stacks, and which not only complicate the device and call for frequent maintenance, but also fail to provide for accurately determining the positions of the ends of the pickup members at the pickup stage.

To eliminate the above drawbacks, some devices are equipped with suction cups for engaging the top blank in the stack for pickup, which is gripped after being lifted out of the respective layer, so that the gripping members can operate without interfering with the adjacent stacks. While eliminating the aforementioned drawbacks, pickup devices of this sort have not proved altogether reliable, on account of lifting the stack by means of suction means engaging the top blank in the stack resulting in deformation of the other blanks, which fan out about the wrapper, thus making the stack difficult to grip. What is more, pickup devices of this sort are unsuitable for loose stacks with no wrappers, in which the blanks simply rest one on top of the other, and which are preferable to the wrapped type by not requiring special devices for removing and disposing of the wrappers.

### DISCLOSURE OF INVENTION

It is an object of the present invention to provide a method of picking up stacks of blanks, designed to eliminate the drawbacks of the known state of the art, and which, in particular, is highly reliable, even for picking up loose stacks of blanks with no wrappers.

According to the present invention, there is provided a method of picking up stacks of blanks by means of a gripping device comprising a frame, a gripper hinged to the frame and equipped with a first gripping member having a free end, and actuating means for activating said gripper; said stacks resting on a support; and the method being characterized by pressing said free end on said support in front of said stack, and feeding said free end along said support and beneath the stack while pressing said free end against the support.

The present invention also relates to a device for picking up stacks of blanks.

According to the present invention, there is provided a device for picking up stacks of blanks, wherein the stacks rest on a support; the device comprising a frame, a gripper hinged to the frame and having a first gripping member having a free end, and actuating means for activating said gripper; and the device being characterized in that said actuating means comprise a first and a second actuator for moving the first gripping member with respect to said frame so as to press said free end on said support in front of said stack, and so as to feed said free end along said support and beneath the stack while pressing said free end against the support.

### BRIEF DESCRIPTION OF THE DRAWINGS

A non-limiting embodiment of the present invention will be described by way of example with reference to the accompanying drawings, in which:

FIGS. 1 to 4 show side views, with parts in section and parts removed for clarity, of a preferred embodiment of a device for picking up stacks of blanks and in the course of four different operating steps;

FIGS. 5 and 6 show side views, with parts in section and parts removed for clarity, of the FIG. 1 device;

FIG. 7 shows a front view of a detail of the FIG. 1 device;

FIG. 8 shows a section, with parts removed for clarity, of the FIG. 4 device along line VIII-VIII.

### BEST MODE FOR CARRYING OUT THE INVENTION

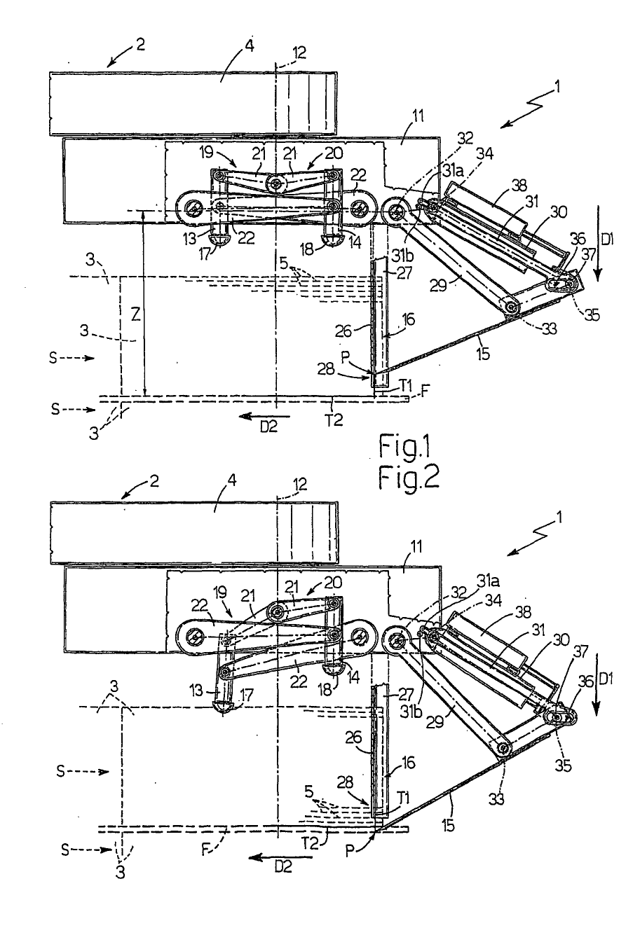

Number 1 in FIG. 1 indicates as a whole a pickup or gripping device of a robot 2 for picking up stacks 3 of blanks stacked on a pallet (not shown), and for transferring stacks 3 to a packing machine (not shown) for producing packets of cigarettes (not shown). Robot 2 comprises a movable arm 4 fitted on the end with device 1, and which positions and orients device 1 in known robot engineering manner.

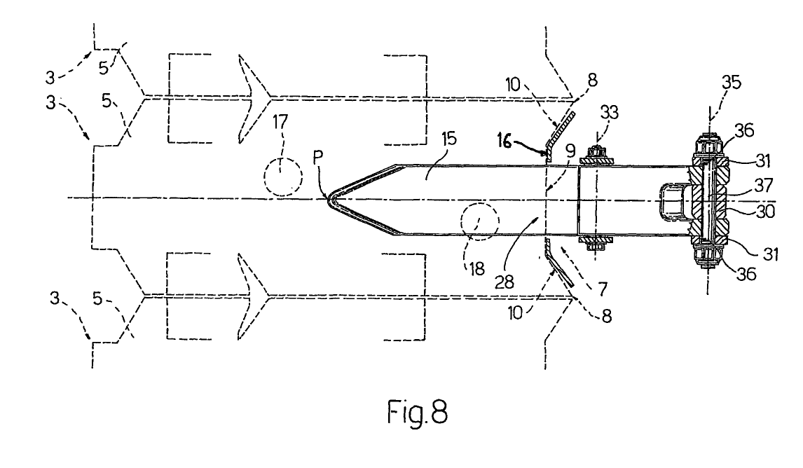

Each stack 3 comprises a number of flat superimposed blanks 5 shaped, when viewed from above, as shown by the dash lines in FIG. 8. Each stack 3 has no wrapper, and is highly deformable when compressed in a direction D1 perpendicular to the faces of blanks 5. Stacks 3 are arranged on the pallet (not shown) in layers S separated by dividers F, which rest firmly on the underlying stacks 3 and extend perpendicular to direction D1. With reference to FIG. 8, each flat blank 5, viewed from above, is of a given shape comprising a recess 7, which extends between two corners 8 and is defined by a central edge 9, and by two sloping edges 10 connecting corners 8 to opposite ends of central edge 9. Blanks 5 in each stack 3 are substantially aligned vertically, so that stack 3 as a whole forms a cavity which, viewed from above, is substantially equivalent to recess 7, is indicated by the same reference number 7, and extends the full height of stack 3.

With reference to FIGS. 1 to 4, device 1 comprises a frame 11 connected to arm 4, and rotates with respect to arm 4 about an axis 12 so as to orient device 1 in known manner with respect to arm 4. Device 1 comprises two fingers 13 and 14 and a blade 15, which are movable with respect to frame 11; and a locating plate 16 integral with frame 11. In other words, fingers 13 and 14, on the one hand, and blade 15, on the other, define the gripping members of a gripper, and cooperate to grip a stack 3.

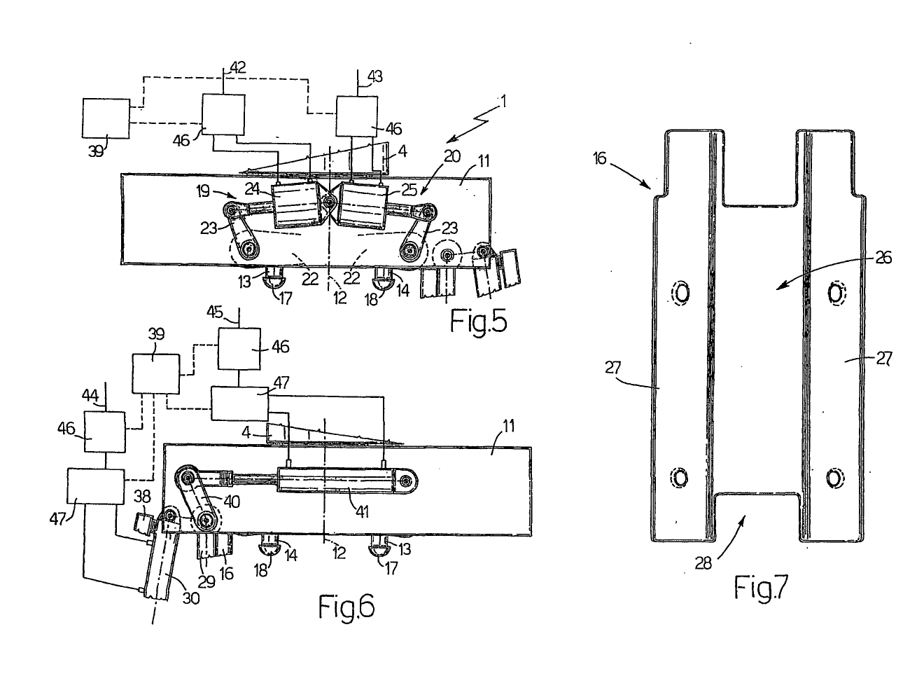

Fingers 13 and 14 comprise respective rounded heads 17 and 18 for contacting the top blank 5 in stack 3; and respective actuators 19 and 20, each of which comprises an articulated quadrilateral defined by a finger 13, 14, by frame 11, and by two rods 21 and 22, of which rod 22 is integral with a crank 23 activated by a respective double-acting pneumatic cylinder 24, 25. Pneumatic cylinders 24 and 25 provide for independently activating respective fingers 13 and 14, which cooperate, one at a time or together, with blade 15 to grip each stack 3. Plate 16 extends parallel to axis 12 and, viewed from above as shown in FIG. 8, is shaped to mate with cavity 7 of each stack 3. With reference to FIG. 7, plate 16 comprises a central body 26 which contacts central edges 9 of blanks 5 in stack 3; and two lateral wings 27 which contact sloping edges 10. Central body 26 comprises a cavity 28 to permit the passage of blade 15 in given operating conditions described later on. In other words, plate 16 provides for locating device. 1 with respect to the stack 3 for pickup.

With reference to FIGS. 1 to 4, blade 15 is substantially rigid and comprises a free end P, and an end portion at the opposite end to free end P and connected to frame 11 by a lever 29, by a double-acting pneumatic cylinder 30, and by two guides 31. Lever 29 rotates with respect to frame 11 about an axis 32 perpendicular to axis 12, while blade 15 rotates with respect to lever 29 about an axis 33 parallel to axis 32. In substantially like manner, pneumatic cylinder 30 is mounted to rotate with respect to frame 11 and blade 15 about respective axes 34 and 35 parallel to axis 32, so as to form with lever 29 an articulated quadrilateral, one side of which (defined by pneumatic cylinder 30) is variable in length. Guides 31 extend along opposite sides of cylinder 30, rotate with respect to frame 11 about axis 34, and have, at the opposite end, respective slots 36 housing a pin 37, which defines axis 35 and the hinge between cylinder 30 and blade 15. Each guide 31 comprises an appendix 31a located at axis 34 and which cooperates with a stop 31b integral with frame 11 to prevent rotation of guides 31 about axis 34. Cylinder 30 is connected to a linear position transducer 38 for detecting a signal related to the extension of cylinder 30, and for transmitting the signal to a control unit 39 controlling the movements of robot 2 and device 1. When lever 29 is positioned as shown in FIGS. 1 and 2, the signal emitted by linear transducer 38 also indicates the position of free end P of blade 15 with respect to axis 32, since the geometry and size of the components of device 1 are known.

With reference to FIG. 6, lever 29 is integral with a crank 40 activated by a double-acting pneumatic cylinder 41 to move lever 29 about axis 32.

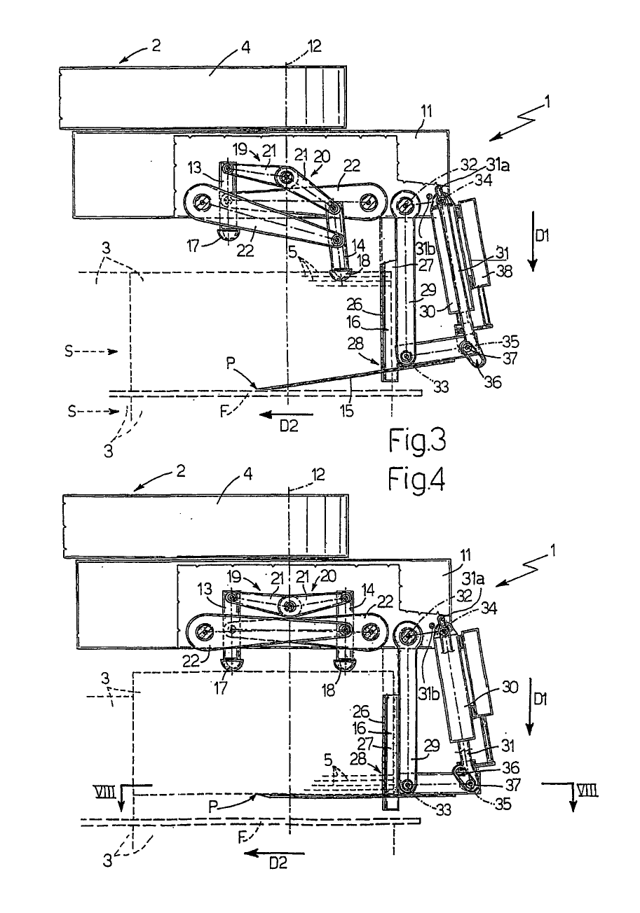

With reference to FIGS. 5 and 6, pneumatic cylinders 24, 25, 30 and 41 are supplied by respective six-bar pneumatic lines 42, 43, 44 and 45, along which are located on-off valves 46 controlled by control unit 39. Downstream from valves 46, lines 44 and 45 are fitted with respective pressure reducers 47 controlled by control unit 39 to supply respective cylinders 30 and 41 at two- or six-bar pressure.

In actual use, robot 2 moves pickup device 1 in known manner between a gripping station—varying in position as a function of the stack 3 for pickup— and the packing machine (not shown). At the gripping station, robot 2 positions frame 11 of device 1 over a stack 3 so that axis 12 is substantially perpendicular to the plane of stacks 3, i.e. the plane defined by divider F supporting the stack 3 for pickup. Robot 2 then locates device 1 with respect to stack 3 underneath, by inserting plate 16 inside cavity 7 and against edges 9 and 10 of blanks 5, so that, at this step, axis 32 is roughly positioned at a distance Z with respect to divider F. The device 1 to stack 3 approach step is monitored by a distance sensor (not shown), which need not be particularly accurate, i.e. may have a tolerance of several millimeters. At the locating and stack 3 approach steps, device 1 is in the FIG. 1 configuration, in which cylinder 30 is fully extended and supplied at six-bar pressure, cylinder 41 is supplied at two-bar pressure, further anticlockwise rotation of guides 31 is prevented by stop 31b, and free end P is located to the right of plate 16 in FIG. 1, in front of cavity 28 of plate 16, which, in addition to the locating function, also acts as a guard to prevent free end P of blade 15 from contacting blanks 5 in the course of the locating and stack 3 approach steps.

Once device 1 is located with respect to stack 3 underneath, control unit 39 inverts the supply of cylinder 30, which is supplied at six-bar pressure and retracted, so that blade 15 rotates anticlockwise about axis 33, while the constraint defined by pin 37 inside slot 36 rotates cylinder 30 clockwise about axis 34 so as to rotate lever 29 clockwise about axis 32. This movement is made possible by any further anticlockwise rotation of guides 31 about axis 34 being prevented, and by cylinder 41 being supplied at two-bar pressure and so acting as a gas spring with respect to the movements determined by cylinder 30 supplied at six-bar pressure. Slot 36 is shaped as a function of the geometry of the device, so that free end P moves along a path T1 substantially parallel to axis 12, without overstepping cavity 28, so as to prevent any contact with blanks 5.

Various operating conditions are possible, depending on distance Z.

In a first operating condition, cylinder 30 is fully retracted, and free end P is positioned at the bottom end of path T1 without coming into contact with divider F. Linear transducer 38 transmits a position signal, indicating cylinder 30 has reached the stop position, to control unit 39, which sets device 1 to the FIG. 1 configuration, reduces distance Z, and repeats the above operation. If the repeat operation gives the same result as before, distance Z is reduced further. If, on the other hand, the travel of free end P along path T1 is arrested by divider F as shown in FIG. 2, and linear transducer 38 emits a position signal falling within a given range, then the pickup operations are continued. In other words, distance Z is adjusted repeatedly until linear transducer 38 emits a position signal falling within a given range and indicating device 1 can proceed to pick up stack 3. The various operating conditions also include one in which distance Z must be increased according to the value of the signal emitted by linear transducer 38.

When pickup is allowed to proceed by control unit 39, i.e. distance Z falls within a given acceptance range, finger 13 is moved from the FIG. 1 to the FIG. 2 position in which head 17 of finger 13 is placed on stack 3 to counteract the thrust exerted by blade 15 inserted beneath stack 3. With reference to FIG. 2, cylinder 30 is supplied at two-bar pressure, while cylinder 41 is supplied at six-bar pressure to extend cylinder 41 and so rotate lever 29 clockwise from the FIG. 2 to the FIG. 3 configuration, in which lever 29 extends parallel to axis 12. That is, rotation of lever 29 about axis 32 and rotation of blade 15 about axis 33 cause free end P to travel along a substantially horizontal path T2 parallel to a direction D2, which is perpendicular to direction D1. The rotation of blade 15 about axis 33 is determined by the flexibility of cylinder 30, which acts as an air spring, while finger 13 prevents stack 3 from being pushed by blade 15 so that stack 3 is no longer centered with respect to device 1. At this step, cylinder 30 acts as a gas spring and is retracted by yielding elastically to the force exerted by the weight of the stack of blanks 5, so that free end P of blade 15 is pressed against divider F to prevent free end P from scraping against the bottom blank 5 in stack 3.

As free end P travels along path T2, finger 13 is withdrawn and finger 14 simultaneously moved forward to rest head 18 on stack 3 and compress stack 3 between finger 14 and blade 15. Fingers 13 and 14 contribute, together with the weight of stack 3, towards keeping free end P in contact with divider F. When cylinder 41 reaches the stop position, cylinder 30 is supplied at six-bar pressure to move cylinder 30 into the fully extended position, so that blade 15 rotates clockwise about axis 33 into a position perpendicular to axis 12 and at a given distance from divider F. In this configuration, shown in FIG. 4, blade 15 moves through cavity 28 and pushes stack 3 against both fingers 13 and 15, which cooperate with blade 15 to hold stack 3 in a given position and enable transfer of stack 3 to the packing machine not shown.

1) A method of picking up stacks of blanks by means of a gripping device (1) comprising a frame (11), a gripper (13, 14, 15) hinged to the frame (11) and equipped with a first gripping member (15) having a free end (P), and actuating means (30, 41; 24, 25) for activating said gripper (13, 14, 15); said stacks resting on a support (F); and the method being characterized by pressing said free end (P) on said support (F) in front of said stack (3), and feeding said free end (P) along said support (F) and beneath the stack (3) while pressing said free end (P) against the support (F).

2) A method as claimed in claim 1, characterized by activating said first gripping member (15) so as to feed said free end (P) towards said support (F) along a first path (T1) parallel to a first direction (D1) substantially perpendicular to said support (F), and along a second path (T2) parallel to a second direction (D2) parallel to said support (F) when said free end (P) is pressed against the support (F).

3) A method as claimed in claim 2, characterized by comprising the steps of detecting a signal related to the limit position assumed by said free end (P) along said first path (T1) and with respect to said frame (11) as the free end is fed towards the support (F); comparing the value of said signal with a given range; moving said free end (P) away from said support (F) along said first path (T1); varying the position of said device (1) with respect to said stack (3) in said first direction (D1); feeding said free end (P) along said first path (T1) towards the support (F); and repeating the preceding steps until the value of said signal falls within said given range.

4) A method as claimed in claim 3, characterized by activating said first gripping member (15) to feed said free end (P) along said second path (T2) beneath said stack (3) when said signal assumes a value falling within said given range.

5) A method as claimed in claim 3 or 4, characterized in that said limit position assumed by said free end (P), as the free end is fed towards the support (F) along said first path (T1), is a function of the actuating means (30, 41) and of the distance (Z) between the device (1) and said stack (3) in said first direction.

6) A method as claimed in any one of claims 1 to 5, characterized in that said actuating means (30, 41, 24, 25) comprise a first and a second actuator (30, 41) which cooperate to activate said first gripping member (15); the method selecting the activating force of the first and second actuator so that the first and second actuator (30, 41) each act both as a spring to permit displacement of said first gripping member (15), and as an actuator to effect active displacement of said first gripping member (15).

7) A method as claimed in claim 6, characterized in that the first and the second actuator (30, 41) are a first and a second pneumatic cylinder (30, 41); the method supplying each cylinder (30; 41) at a first pressure and at a second pressure; the second pressure being greater than the first pressure.

8) A method as claimed in claim 7, characterized in that said first pneumatic cylinder (30) effects the active displacement of said free end (P) along said first path (T1), while said second pneumatic cylinder (41) acts as a gas spring.

9) A method as claimed in claim 7 or 8, characterized in that said second pneumatic cylinder (41) effects the active displacement of said free end (P) along said second path (T2), while said first pneumatic cylinder (30) acts as a gas spring.

10) A method as claimed in any one of claims 1 to 9, characterized in that said gripper (13, 14, 15) comprises a second gripping member (13; 14; 13,14) activated independently of the first gripping member (15).

11) A method as claimed in claim 10, characterized in that said second gripping member (13; 14; 13, 14) comprises a first and a second finger (13, 14) which are brought into contact with said stack (3) to counteract the action of the first gripping member (15); the first and second finger (13, 14) being activated independently of each other as a function of the position of the first gripping member (15).

12) A device for picking up stacks of blanks, wherein the stacks (3) rest on a support (F); the device (1) comprising a frame (11), a gripper (13, 14, 15) hinged to the frame (11) and having a first gripping member (15) having a free end (P), and actuating means (30, 41; 24, 25) for activating said gripper (13, 14, 15); and the device being characterized in that said actuating means (30, 41, 24, 25) comprise a first and a second actuator (30, 41) for moving the first gripping member (15) with respect to said frame (11) so as to press said free end (P) on said support (F) in front of said stack (3), and so as to feed said free end (P) along said support (F) and beneath the stack (3) while pressing said free end (P) against the support (F).

13) A device as claimed in claim 12, characterized in that said first gripping member (15) is connected to said frame (11) by an articulated quadrilateral having a variable-length side; said quadrilateral being controlled by said first and said second actuator (30, 41) to so activate said first gripping member (15) as to feed said free end (P) towards said support (F) along a first path (T1) parallel to a first direction (D1) substantially perpendicular to said support (F), and along a second path (T2) parallel to a second direction (D2) parallel to said support (F) when said free end (P) is pressed against the support (F).

14) A device as claimed in claim 13, characterized by comprising a position sensor (38) associated with the variable-length side of said articulated quadrilateral to determine the length of said variable-length side; the length of said variable-length side being related to the position of said free end (P) along said first path (Ti).

15) A device as claimed in claim 14, characterized in that the variable-length side of said articulated quadrilateral is defined by said first actuator (30); the side opposite the variable-length side being defined by a lever (29); and the other sides being defined by said frame (11) and by said first gripping member (15).

16) A device as claimed in any one of claims 12 to 15, characterized in that the first and the second actuator (30, 41) are a first and a second pneumatic cylinder (30, 41); the device providing for supplying each cylinder at a first pressure and a second pressure; the second pressure being greater than the first pressure, so that one of said first and second pneumatic cylinders (30, 41) acts as an actuator when supplied at the second pressure, and the other acts as a gas spring when supplied simultaneously at the first pressure.

17) A device as claimed in claim 16, characterized in that said articulated quadrilateral comprises at least one guide (31) to guide said first pneumatic cylinder (30).

18) A device as claimed in any one of claims 12 to 17, characterized in that said gripper (13, 14, 15) comprises a second gripping member (13; 14; 13, 14), and a third and a fourth actuator (24, 25) for activating said second gripping member (13; 14; 13, 14) independently of the first gripping member (15).

19) A device as claimed in claim 18, characterized in that said second gripping member (13; 14; 13, 14) comprises a first and a second finger (13, 14) which are brought into contact with said stack (3) to counteract the action of the first gripping member (15); the third actuator and the fourth actuator respectively activating the first and the second finger (13, 14) independently of each other as a function of the position of the first gripping member (15).

20) A device as claimed in any one of claims 12 to 19, characterized in that said first gripping member (15) is a substantially rigid blade (15).

21) A device as claimed in any one of claims 12 to 20, characterized by comprising a locating member (16) integral with said frame (11) and insertable inside a reference cavity (7) of said stack (3).

22) A device as claimed in claim 21, characterized in that said locating member (16) is a contoured plate (16) which mates with said cavity (7); said stack (3) and said first gripping member (15) being located on opposite sides of said plate (16) as the plate is mated with the cavity.
